(19) United States
(12) Patent Application Publication
(10) Pub. No.: US 2019/0016968 A1
(43) Pub. Date: Jan. 17, 2019

(54) ELECTRO-KINETIC SEPARATION OF SOLID PARTICLES FROM HYDROCRACKER STREAMS

(71) Applicant: ExxonMobil Research and Engineering Company, Annandale, NJ (US)

(72) Inventors: Ivy D. Johnson, Lawrenceville, NJ (US); Bhupender S. Minhas, Bridgewater, NJ (US); Jessica Wittman, Easton, PA (US); Sara L. Yohe, Houston, TX (US); Thomas Bruno, Stanhope, NJ (US)

(21) Appl. No.: 16/017,004

(22) Filed: Jun. 25, 2018

Related U.S. Application Data
(60) Provisional application No. 62/532,053, filed on Jul. 13, 2017.

(51) Int. Cl. C10G 32/02; C10G 53/02; B03C 5/02; B03C 5/00

(52) U.S. Cl. CPC C10G 32/02; C10G 53/02; B04C 2009/001; B03C 5/005; B03C 5/024

(57) ABSTRACT

Electro-kinetic separation processes for removing solid particles from hydrocracker process streams are provided herein.

### CROSS-REFERENCE TO RELATED APPLICATIONS

This application claims priority to U.S. Provisional Application Ser. No. 62/532,053 filed Jul. 13, 2017, which is herein incorporated by reference in its entirety.

### FIELD OF THE INVENTION

This invention relates to electro-kinetic separation processes for removal of solid particles from hydrocarbon process streams, such as feed streams for or effluents from a hydrocracker.

### BACKGROUND OF THE INVENTION

One method for increasing the feedstocks suitable for production of fuels and lubricants can be to conduct cracking to convert higher boiling petroleum feeds to lower boiling products. For example, high vacuum gas oils and low vacuum gas oils can be hydrocracked to generate additional lubricant base stock range products.

Base stocks are commonly used for the production of lubricants, such as lubricating oils for automotives, industrial lubricants and lubricating greases. A base oil is defined as a combination of two or more base stocks used to make a lubricant composition. They are also used as process oils, white oils, metal working oils and heat transfer fluids. Finished lubricants consist of two general components, lubricating base stock and additives. Lubricating base stock is the major constituent in these finished lubricants and contributes significantly to the properties of the finished lubricant. In general, a few lubricating base stocks are used to manufacture a wide variety of finished lubricants by varying the mixtures of individual lubricating base stocks and individual additives.

According to the American Petroleum Institute (API) classifications, base stocks are categorized in five groups based on their saturated hydrocarbon content, sulfur level, and viscosity index (Table 1). Lube base stocks are typically produced in large scale from non-renewable petroleum sources. Group I, II, and III base stocks are all derived from crude oil via extensive processing, such as solvent extraction, solvent or catalytic dewaxing, and hydroisomerization. Group III base stocks can also be produced from synthetic hydrocarbon liquids obtained from natural gas, coal or other fossil resources, Group IV base stocks, the polyalphaolefins (PAO), are produced by oligomerization of alpha olefins, such as 1-decene, Group V base stocks include everything that does not belong to Groups I-IV, such as naphthenics, polyalkylene glycols (PAG), and esters.

Hydrocrackers are refinery operations used to upgrade hydrocarbon streams. The process receives feeds from multiple sources, some of which contain significant levels of particulates which have a deleterious impact on downstream product specifications, as well as equipment erosion and plugging. Therefore, the feeds and/or products of a hydrocracker require filtration or centrifugation to remove particulates either before or after the hydrocracker/hydrotreators. Alternatively, the feeds sent to the hydrocracker could be limited to those feeds with low particle counts.

The process stream exiting the hydrocracker can contain, in addition to the desired lubricant range petroleum products, solid particles (particulate) originating from catalysts, the reactor equipment, and the reactants. Solid particles, even if contained in the lubricant base stock product at a low concentration, can be detrimental to the performance of the end product, if not reduced to an acceptable level. For example, it is known that solid particles contained in a lubricant base stock, if at an unacceptable level, can cause visual haziness or cloudiness of the final lubricant composition formulated from the base stock, increase deposit formation in the lubricant, decrease filtrability of the lubricant, reduce its lubricating efficacy, and increase surface corrosion and surface wear of the lubricated components, leading to shortened life span of the lubricant and higher risk of premature failure or higher energy consumption of the lubricated equipment.

Historically, the particle-containing hydrocracker process feed streams and/or effluent (hydrocrackate) are passed through one or more stages of mechanical filtration or centrifugation to at least partially remove the solid particles contained therein. Mechanical filtration may involve passing the reaction product through a porous membrane with pores that are small enough to exclude a portion of the solid particles. However, the filtration rate can be negatively impacted by various factors, such as the viscosity of the reaction product, the amount of solids to be removed, and/or the morphology of the solids. Reducing the filtration time can improve production capacity as well as allow for more highly particulate-contaminated feeds to be used in the process.

Porous membrane filtration often requires the use of a filtration aid, typically in the form of diatomaceous earth, which forms a layer on the membrane filter to help collect solids that would otherwise bypass or clog the filter. After filtration, the filtration aid together with the solid particles in the process stream form a “filter cake” on the surface of the membrane filter. This cake will have absorbed liquid product from the product stream. Direct disposal of the filter cake with the absorbed liquid product is wasteful; while reclamation of the absorbed liquid product requires additional materials and steps. The compromise between particle filtration speed and degree of partial removal results in at least a portion of the solid particles, especially those having a particle size smaller than the pore size of the membrane, passing through the membrane and become entrained in the process stream after filtration.

It would be advantageous to have a process which removes solid particles from hydrocracker process streams at a faster rate than conventional filtration technology and/or reduces the amount of solid particles which need to be removed by conventional filtration.

### SUMMARY OF THE INVENTION

It has been found that electro-kinetic separation (“EKS”) can be used to effectively reduce solid particles, even those with exceptionally small size, from hydrocracker process streams without the need of filtration, or in addition to filtration or centrifugation. The EKS media laden with collected solid particles can be conveniently regenerated in-situ or ex-situ to reclaim utilized particle-abatement capacity of the EKS, or in some circumstances discarded and replaced with fresh EKS media.

Thus, in one aspect, the present invention provides a process for reducing particulates in a hydrocarbon process stream, comprising either a hydrocracker feed stream or a hydrocrackate stream and particulates, the process comprising removing at least a portion of the particulates from the hydrocarbon process stream by passing the hydrocarbon process stream through at least one electrokinetic separator (EKS) to form a particulate-reduced hydrocarbon stream.

In one form, the hydrocarbon process stream is a feed stream for a hydrocracker.

In one form, the hydrocarbon process stream is hydrocrackate exiting a hydrocracker.

In another form, the process can further comprise filtering the particulate-reduced hydrocarbon stream with sub-micron filters.

Advantageously, the reduction in particulates off-loads the filters and reduces time for regenerating the filters.

In yet another form, the process can further comprise processing the particulate-reduced hydrocarbon stream with a hydrocyclone system or a centrifuge system as a polishing step.

Additionally, the process can further comprise running the hydrocarbon stream through a hydrocyclone upstream of the EKS, or running the hydrocarbon stream through a filtration system upstream of the EKS, or even running the hydrocarbon stream through a centrifuge system upstream of the EKS.

In another form, the particulates have an average particle size in the range from 0.1 to 10 micrometer.

In yet another form, at least 50 wt % of the particulates are derived from a hydrocarbon processing catalyst.

In another form, the particulates comprise particles derived from catalysts, clay, particles derived from reactor equipment, and particles derived from post-reaction treatment before the EKS.

In yet another form, the EKS comprises at least two opposite electrodes with differing electrical potentials applying an electric field, and an EKS media disposed between the electrodes, wherein the EKS media comprises fibers, fabrics, flakes, foams, pellets, beads, wires, or combinations thereof.

Advantageously, the EKS media comprises a fabric, and the process stream flows through a channel formed at least partially from the fabric.

Alternatively, the EKS media comprises pellets or beads made from materials selected from inorganic glasses, ceramics, glass-ceramics, inorganic oxides, and mixtures and combinations thereof.

In another form, the process further comprises a step of regenerating the EKS media, such as by washing the EKS media by recycling a portion of the particulate-reduced hydrocarbon stream to the EKS, thereby removing at least a portion of the particles collected in the EKS media, or by washing the EKS media by using a process-compatible washing fluid to remove at least a portion of the particles collected in the EKS media.

In one form, the process-compatible washing fluid is selected from the group consisting of air, nitrogen, a hydrocarbon containing liquid and combinations thereof.

Advantageously, the particulates are removed in a direction different from a flow direction of the hydrocarbon process stream.

Other embodiments, including particular aspects of the embodiments summarized above, will be evident from the detailed description that follows.

### BRIEF DESCRIPTION OF THE DRAWINGS

The drawings described herein are for illustrative purposes only of selected embodiments and not all possible implementations, and are not intended to limit the scope of the present disclosure.

FIGS. 1A and 1B schematically illustrate an EKS comprising a fabric EKS media operating in the cleaning mode.

FIG. 2 schematically illustrates an EKS comprising glass beads as the EKS media operating in the cleaning mode.

Corresponding reference numerals indicate corresponding parts throughout the several views of the drawings.

### DETAILED DESCRIPTION OF THE INVENTION

This application illustrates an alternative or addition to filtration of hydrocracker process streams, which reduces particle count independent of particle size.

### Definitions

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than the broadest meaning understood by skilled artisans, such a special or clarifying definition will be expressly set forth in the specification in a definitional manner that provides the special or clarifying definition for the term or phrase.

For example, the following discussion contains a non-exhaustive list of definitions of several specific terms used in this disclosure (other terms may be defined or clarified in a definitional manner elsewhere herein). These definitions are intended to clarify the meanings of the terms used herein. It is believed that the terms are used in a manner consistent with their ordinary meaning, but the definitions are nonetheless specified here for clarity.

A/an: The articles “a” and “an” as used herein mean one or more when applied to any feature in embodiments and implementations of the present invention described in the specification and claims. The use of “a” and “an” does not limit the meaning to a single feature unless such a limit is specifically stated. The term “a” or “an” entity refers to one or more of that entity. As such, the terms “a” (or “an”), “one or more” and “at least one” can be used interchangeably herein.

About: As used herein, “about” refers to a degree of deviation based on experimental error typical for the particular property identified. The latitude provided the term “about” will depend on the specific context and particular property and can be readily discerned by those skilled in the art. The term “about” is not intended to either expand or limit the degree of equivalents which may otherwise be afforded a particular value. Further, unless otherwise stated, the term “about” shall expressly include “exactly,” consistent with the discussion below regarding ranges and numerical data.

And/or: The term “and/or” placed between a first entity and a second entity means one of (1) the first entity, (2) the second entity, and (3) the first entity and the second entity. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements). As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of”.

Comprising: In the claims, as well as in the specification, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03. Any device or method or system described herein can be comprised of, can consist of, or can consist essentially of any one or more of the described elements.

Ranges: Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a range of about 1 to about 200 should be interpreted to include not only the explicitly recited limits of 1 and about 200, but also to include individual sizes such as 2, 3, 4, etc. and sub-ranges such as 10 to 50, 20 to 100, etc. Similarly, it should be understood that when numerical ranges are provided, such ranges are to be construed as providing literal support for claim limitations that only recite the lower value of the range as well as claims limitation that only recite the upper value of the range. For example, a disclosed numerical range of 10 to 100 provides literal support for a claim reciting “greater than 10” (with no upper bounds) and a claim reciting “less than 100” (with no lower bounds). In the figures, like numerals denote like, or similar, structures and/or features; and each of the illustrated structures and/or features may not be discussed in detail herein with reference to the figures. Similarly, each structure and/or feature may not be explicitly labeled in the figures; and any structure and/or feature that is discussed herein with reference to the figures may be utilized with any other structure and/or feature without departing from the scope of the present disclosure.

“Mechanical filtration” herein refers to a filtration process for separating a solid matter from a solid/fluid mixture effected only through traditional mechanical forces resulting from gravity, centrifugation, pressure gradient (vacuum or positive pressure), and the like, and combinations thereof, without intentionally exerting an external force to the solid matter to be separated from a liquid by an electric field. A rotary drum filter assisted with vacuum is a widely used mechanical filtration device for separating solids from liquids.

“Hydrocracking” as used herein refers generally to a catalytic process of cracking long hydrocarbon chains into shorter hydrocarbon chains, so as to derive more useful products. Many patents disclose hydrocracking processes, such as U.S. Pat. No. 9,499,752, which is incorporated herein by reference in its entirety.

Manufacture of lubricant base stocks often begins with rather high boiling point hydrocarbon fractions, such as light vacuum gas oil (LGO) or heavy vacuum gas oil (HGO) which are derived from the vacuum distillation column in a refinery. During processing, the LGO or HGO materials are often passed through several different catalytic processes to alter their compositions and/or remove certain impurities. Invariably, at least some particulate, such as catalyst fines or scale from upstream processing equipment find their way into the hydrocarbon process stream for the hydrocracker. Likewise, since the hydrocracker itself is a catalytic device, catalyst fines from the hydrocracker can be entrained in the hydrocrackate; i.e. the effluent from the hydrocracker. Conventionally, removal of the particulate is performed by mechanical filtration, whereby the hydrocarbon process stream is passed through one or more filtration membranes prior to passing it into the hydrocracker.

Time, equipment, and process conditions required for filtration to the desired level of particle count can be affected by many factors, including but not limited to the viscosity of the process stream and the amount of solid particles to be removed. The particulate intended for removal typically accumulates in the mechanical filter to form a “filter cake,” which also contains a liquid of the desired product. The filter cake can be disposed of directly together with the liquid contained therein, resulting in waste of a portion of the desired product and unreacted reactant. Alternatively, the filter cake can be washed using a washing fluid to reclaim the liquid entrained therein. Because the mechanical filtration equipment and process requires the use of a filtration membrane with a limited pore size, it is possible that even after multiple stages of mechanical filtration, certain solid particles, especially those with sizes smaller than the pores of the filtration membrane, cannot be removed completely.

Thus, the present disclosure addresses such problems by providing a particulate abatement process for hydrocracker feed stock and/or hydrocrackate, collectively a hydrocracker fluid, using an electro-kinetic separator device (“EKS”). In this discussion, electrokinetic separation is defined as a filtration process that captures particulate entrained in a hydrocracker fluid according to electrokinetic, dielectrophoresis, and/or electrophoresis principles and produces a hydrocracker fluid with reduced particulate counts. The EKS can be placed upstream of the hydrocracker, or downstream of the hydrocracker, or both. It can be advantageous if the EKS device is placed in a slipstream of the hydrocracker fluid, such that it treats only a portion of the total fluid volume.

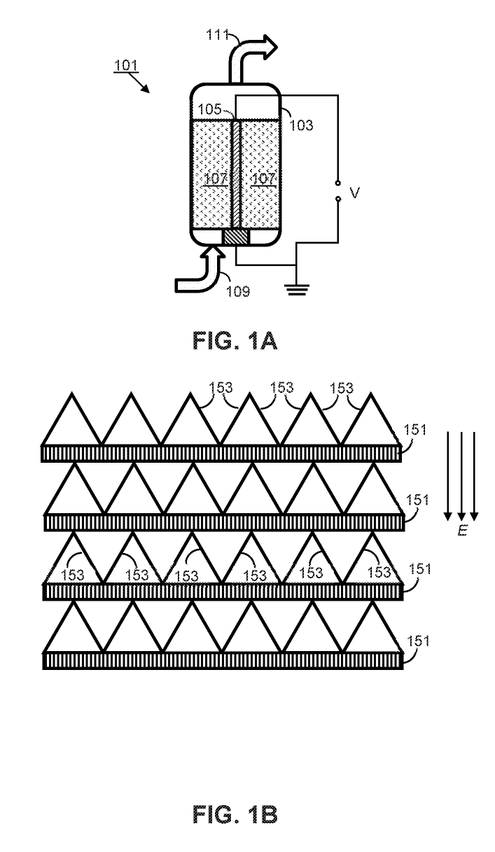

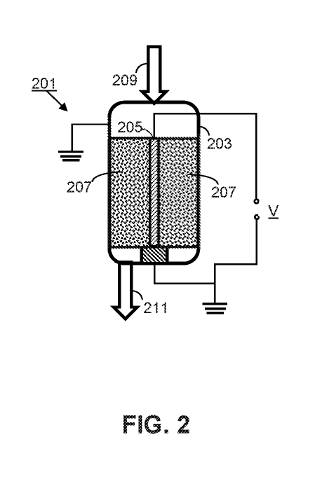

Examples of EKS devices suitable for use with the process streams of the present application are depicted in FIGS. 1A and 1B, which is an EKS comprising a fabric EKS media operating in the cleaning mode, and FIG. 2 which is an EKS comprising glass beads as the EKS media operating in the cleaning mode.

The separation is performed by applying an electrical voltage to electrodes that are separated by a dielectric medium, creating an electric field. A direct current (DC) or alternating current (AC) voltage may be applied to the electrodes. The hydrocracker fluid flows through the resulting electric field, and as a result of Coulomb's Law, solid particles, such as catalyst particles, bearing an electrical charge or polarized electric charge distribution, can move in desired directions in the electric field, attach to the dielectric medium and become immobilized. The net result is the hydrocracker fluid exiting the EKS contains a reduced amount of particulate.

A great majority of the particulate contained in the process stream treated by the process of the present invention may be derived from the solid catalysts upstream of the hydrocracker. For example, the percentage by weight of the particulate in the fresh process stream entering the EKS supplied from an upstream equipment, based on the total weight of the particulate entrained in the fresh process stream, can be in the range from a1% to a2%, where al and a2 can be, independently, 80, 85, 90, 95, 96, 97, 98, 99, 100, as long as a1<a2.

The particulate may have an average particle size of from about 0.1 to about 10 micrometer (μm), such as from about 0.1 to about 1 μm, or about 0.1 to about 0.5 μm, or even from about 0.1 to about 0.2 μm, measured by via a hot toluene filtration/wash protocol, ASTM method D4807-05.

In certain variations, the temperature of the process stream may be adjusted to a desirable level by a heat exchanger before entering the EKS to optimize the viscosity of the process stream undergoing electrokinetic separation. As such, it is contemplated that the process stream entering the EKS can have a relatively high temperature.

The EKS can be used in combination with traditional mechanical filtration apparatus. In such embodiments, the EKS is preferably located downstream of at least one mechanical filtration apparatus, although it can be advantageous to locate the EKS upstream of the mechanical filtration apparatus. The EKS has the ability of capturing very fine particles that have passed through the filter membrane of a mechanical filtration apparatus, hence the advantage of placing an EKS downstream a traditional mechanical filtration apparatus.

The EKS comprises at least two electrodes made of electrical conductors capable of conducting electricity at the operating conditions. The electrodes can be made of any such conductors, such as carbon, silicon, metals and metal alloys (e.g., aluminum, copper, silver, gold, and other precious metals, conductive ceramics, and the like).

During operation, a voltage is applied to the electrodes, creating an electric field between them. The process stream is allowed to pass through the electric field, typically in a direction intercepting the electric field. Solid particles bearing electrical charges are forced to travel in the electric field as a result of the Coulomb force exerted thereon. Neutral solid particles can be induced to become electrically polarized in the electric field, and then move in a certain direction as a result of the Coulomb force.

The amplitude of the voltage applied and the characteristics of the voltage profile (e.g., constant DC, alternating sinusoid, alternating flat pulses, or other profiles), the type of electrode material, shape, dimension, and position of the electrodes, as well as the distance between the electrodes, can be chosen by one skilled in the art to meet the need of the specific process of the invention: flow rate of the fresh feed stream, operating temperature, particle concentration in the fresh feed stream, number of EKS used, particle concentration required for the stream passed on to the downstream equipment, and the like.

Further, as described above, the EKS may comprise a dielectric medium (the “EKS media”) disposed between the electrodes applying the electric field. Suitable EKS media contemplated herein includes any solid material that has a low electrical conductivity under the operating conditions of the EKS. Preferably, the EKS media has an electrical conductivity lower than the electrode material. Preferably, the EKS media has an electrical conductivity lower than the process stream fluid under the operating conditions. Non-limiting examples of suitable EKS media includes fibers, fabrics (e.g., non-woven or woven, cellulose and the like), flakes, foams, pellets, beads or wires, made of materials such as glass, ceramic, glass-ceramic, inorganic oxides, cellulosic materials such wood, and combinations and mixtures thereof. In one embodiment, the EKS media may be fabric, such as a non-woven fabric. The fabric may at least partially form channels of any suitable geometry through which the process stream fluid may flow. While the process stream flow through the channels and the electric field, solid particles can be attracted to the fabric, adhere to the fabric, and collected on the fabric, without being carried to the downstream equipment, to achieve the particle abatement effect.

In various aspects, the EKS can be operated at a pressure of about 100 kPaa (kilopascal absolute pressure) to about 3500 or about 100 kPaa to about 3000 kPaa, or about 100 kPaa to about 2500 kPaa, or about 100 kPaa to about 2000 kPaa, or about 100 kPaa to about 1500 kPaa, or about 100 kPaa to about 1000 kPaa, or about 100 kPaa to about 500 kPaa, or about 250 kPaa to about 3500 kPaa, or about 250 kPaa to about 3000 kPaa, or about 250 kPaa to about 2500 kPaa, or about 250 kPaa to about 2000 kPaa, or about 250 kPaa to about 1500 kPaa, or about 250 kPaa to about 1000 kPaa, or about 250 kPaa to about 500 kPaa, or about 500 kPaa to about 3500 kPaa, or about 500 kPaa to about 3000 kPaa, or about 500 kPaa to about 2500 kPaa, or about 500 kPaa to about 2000 kPaa, or about 500 kPaa to about 1500 kPaa, or about 500 kPaa to about 1000 kPaa.

As discussed herein, the treated stream exiting the EKS has a reduced content of particles compared to the fresh stream entering the EKS. In various aspects, the treated product stream may comprise solid particles in a concentration, as measured by ASTM D4807-05, of less than about 10,000 ppmw (parts per million by weight), less than about 7,500 ppmw, less than about 5,000 ppmw, less than about 2,500 ppmw, less than about 1,000 ppmw, less than about 750 ppmw, less than about 500 ppmw, less than about 250 ppmw, less than about 100 ppmw, less than about 75 ppmw, less than about 50 ppmw, less than about 25 ppmw, less than about 10 ppmw, less than about 1.0 ppmw, or less than about 0.50 ppmw or about 0.010 ppmw, based on the total weight of the process fluid exiting the EKS. Additionally or alternatively, the treated product stream may comprise solid particles in a concentration of about 0.010 ppmw to about 10,000 ppmw, about 0.010 ppmw to about 5,000 ppmw, about 0.010 ppmw to about 1,000 ppmw, about 0.010 ppmw to about 100 ppmw, about 0.010 ppmw to about 50 ppmw, about 0.010 ppmw to about 10 ppmw, or about 0.010 ppmw to about 1.0 ppmw.

The EKS can be advantageously used for process streams containing solid particles that have small sizes, such as those having an average particle size of at most 1 micrometer (μm), such as less than 0.2 μm or 0.1 μm.

As the process stream flows through the EKS, the EKS media can reach a desired level of captured particulate, such as any convenient amount up to the maximum capacity of the EKS media for capturing and retaining solids. This desired capacity of the EKS can be determined by many factors, including but not limited to the voltage profile applied to the electrodes, flow rate of the process stream, particulate density and particle size distribution in the process stream, the type and capacity of the EKS media used for collecting solid particles, and the like.

When the EKS media reaches its particle collection capacity, it may be desirable to regenerate the EKS media to remove at least a portion of the collected particulate from the EKS media, thereby reclaiming or restoring at least part of the capacity. One contemplated regeneration process includes removing the soiled EKS media from the EKS device, cleaning the media by using mechanical, chemical, electrical means, and combinations thereof, and re-installing the thus cleaned media into the EKS device. Solvents, detergents, flames, oxidizing agents, plasma, brushes, stirring device, flushing fluid streams, and the like, may be used for cleaning the soiled EKS media.

Alternatively, an in-situ regeneration process is used where the EKS media is allowed to remain in the EKS device during regeneration. During such in-situ regeneration process, supply of the process stream to the EKS may be turned off partly or completely, and voltage applied to the EKS electrodes may be reduced to zero or changed to a profile favorable for releasing captured particulate so that it may be flushed out of the EKS. During in-situ regeneration of the EKS media, a process compatible fluid as a backwash fluid is passed through the EKS, whereby at least a portion of the particulate collected in the media is flushed out. The process compatible fluid may be any suitable fluid (including liquids, gases and mixtures thereof), including but not limited to: air, nitrogen, hydrocarbons (e.g., methane, ethane, butane, hexane, cyclohexane, and the like), or solvents. Preferably, the process-compatible washing fluid is miscible with the process stream fluid.

Where hydrocrackate product stream is supplied to the EKS as a backwash fluid to remove at least a portion of the particulate collected therein, at least about 1% to about 20% or about 5% to about 10% of the treated hydrocrackate product stream may be recycled through the EKS to collect the deposited particulate. After exiting the EKS, the backwash fluid can be further passed to a separation system (such as a mechanical filter, a settling tank, an EKS, or other separation devices) to remove particulate therefrom. The thus reclaimed backwash fluid may be used for all suitable purposes.

Additionally or alternatively, instead of regenerating the EKS media, the EKS media may be replaced once the EKS media reaches a desired level of captured particulate as described herein. For example, the EKS media may be replaced after one separation cycle, two separation cycles, three separation cycles, four separation cycles, or five separation cycles. For example, a first separation cycle can comprise passing a designated process stream volume through the EKS to produce the treated hydrocracker process or product stream and a second cycle can comprise passing at least a portion of the treated hydrocracker process or product stream through the EKS and so on. Alternatively, a first separation cycle can comprise passing a first designated process stream volume through the EKS to produce a first treated hydrocracker fluid and a second cycle can comprise passing a second designated process stream volume through the EKS to produce a second treated hydrocracker fluid.

Alternatively, a continuous fresh feed stream supplied from the equipment upstream the EKS is passed through the EKS to obtain a particulate-reduced stream, which is then split into at least two streams, one of which is recycled to the EKS, and the other to the downstream equipment, which can be a downstream EKS, a hydrocracker, a distillation column, a storage unit, or other vessels. The ratio of the weight of the stream recycled to the EKS to the weight of the fresh feed stream entering the EKS can vary significantly depending on the particle concentration in the fresh feed stream entering the EKS, the efficiency and capacity of the EKS, and the desired particle concentration in the stream allowed to leave to the downstream equipment. Desirably, the recycle ratio can range from r1 to r2, where r1 and r2 can be, independently, 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, as long as r1<r2. At a given EKS capacity and efficiency and all other process conditions held equal, the higher the recycle ratio, the lower the concentration of particulate in the stream passed on to the downstream equipment will be.

A plurality of EKS units can be used, which are connected in parallel or in series, or in both fashions, to meet the solid particle abatement performance requirements of the process. Preferably, at least two of the multiple EKS units are configured such that they are capable of being operated in parallel, i.e., both receiving fresh stream from the same upstream equipment. A system having the capability of operating multiple EKS units in parallel permits the possibility of operating one EKS in cleaning mode (i.e., a mode where fresh feed stream is accepted and a treated product stream is produced) and operating one EKS in regeneration mode or idling mode if needed, thus allowing for a steady and uninterrupted operation of the whole product manufacture system.

The present invention can be used in a system and process for making particle-reduced hydrocarbon streams without the need of the use any filtration equipment other than the EKS. Alternatively, as discussed above, the EKS can be used in conjunction with other filtration equipment such as traditional mechanical filter apparatuses. While preferably the EKS is downstream of a conventional mechanical filter, it is contemplated that in certain situations, a mechanical filter may be installed and used downstream of an EKS. An upstream EKS can reduce the particle load applied to the downstream mechanical filter, such that the reduction in particulates off-loads the filters and reduces time for regenerating the filters.

The processes described herein may also include steps of processing a particulate-reduced hydrocrackate stream with a hydrocyclone system or a centrifuge system as a polishing step. In another form, the hydrocracker feed stream can be run through a hydrocyclone, or a filtration system, or even a centrifuge system upstream of the EKS.

The particulate released form the EKS during regeneration process can be recycled to the hydrocracker where appropriate. Thus, the wash stream containing the process-compatible back-wash fluid can be directly recycled to the hydrocracker for that purpose, especially if the back-wash fluid contains the hydrocrackate. In certain situations, it may be desirable to separate the solid particles from the fluid in the wash stream in a settling tank or other devices, and then recycle a stream containing enriched solid particles at an elevated loading to the hydrocracker. To the extent the solid particles collected by the EKS contain primarily those derived from the hydrocracker, recycling the particles released from the EKS to the hydrocracker can be particularly advantageous.

### EXAMPLES

A schematic of the fabric media EKS 101 (Kleentek electrostatic oil conditioning system available from United Air Specialists Inc., Blue Ash, Ohio, United States) in operation is shown in FIG. 1A. The EKS comprises a stainless steel shell 103, which is grounded and serves as one of the two EKS electrodes. Inside shell 103, a longitudinal metal rod 105, electrically separated from the shell at the bottom, was installed as the opposing EKS electrode. A dielectric EKS media 107 made of non-woven pleated fabric was placed between the electrode 105 and the shell 103. During operation in the cleaning mode, a high voltage V was applied between electrode 105 and the shell 103, generating an electric field in the space between. Particle-laden streams of feeds 109 were pumped into the EKS from the bottom and allowed to flow through the EKS media 107 and the electric field, and exit EKS from the top as stream 111. FIG. 1B shows a schematic of a local structure of the fabric EKS media 107 comprising multiple fabric walls 151 and 153 defining fluid channels extending generally in the longitudinal direction along the desired upward stream flow direction. The stream flow direction in the media (not shown) in FIG. 1B is substantially perpendicular to the paper, while the direction of the electric field (“E”) is substantially perpendicular to the series of primary structural walls 151. While the local sections of walls 151 are shown as flat in FIG. 1B, macroscopically they can be curved (e.g., forming a cylindrical sleeves enclosing the electrode 105 in the center thereof). During operation in the cleaning mode, at least a portion of the solid particles in the liquid stream 109 entering the EKS bearing charges or induced partial charges move toward the fabric walls 151 and 153 as a result of the Coulomb force exerted by the electric field, contact and adhere to the fabric surface due to the fabric surface micro-structure and the Coulomb force, and become immobilized. The net effect is a reduced quantity of particles in stream 111 exiting the EKS compared to stream 109 entering the EKS.

A schematic of a glass bead media EKS 201 (Gulftronic™ electrostatic separators available from General Atomics, 3550 General Atomics Court, San Diego, Calif. 92121-1122, United States) in operation is shown in FIG. 2. The glass bead media EKS comprises a metal shell 203, which is grounded and serves as one of the two EKS electrodes. Inside shell 203, a longitudinal metal rod 205, electrically separated from the shell at the bottom, is installed as the opposing EKS electrode. A dielectric EKS media 207, made of a plurality of glass beads, is placed between the electrode 205 and the shell 203. During operation in the cleaning mode, a high voltage V is applied between electrode 205 and the shell 203, generating an electric field in the space between. Particle-laden streams of feeds 209 are supplied into the EKS from the top and allowed to flow downwards through the EKS media 207 and the electric field, and exit the EKS from the bottom as stream 211. At least a portion of the solid particles entrained in the liquid stream 209 entering the EKS bearing charges or induced partial charges move toward the shell 203 or electrode 205 as a result of the Coulomb force exerted by the electric field, contact and adhere to the surfaces of the glass beads due to surface micro-features and the Coulomb force, and become immobilized. The net effect is a reduced quantity of particles in stream 211 exiting the EKS compared to stream 209 entering the EKS.

### Example 1

### Separation Using EKS with Fabric EKS Media

A sample of hydrocrackate was obtained and passed through two different sub-micron filters to determine the amount of solid particles greater than the pore size of each filter which was contained in the hydrocrackate. Subsequently, the hydrocrackate was fed to a fabric media EKS unit with and without current applied. The results of the tests are shown in the Table below.

TABLE

| | | ppm solids | ppm solids |
|---|---|---|---|
| | Sample | collected w/0.45 | collected w/0.8 |
| Example # | Description | μm filter | μm filter |
| 1 fed to filters only | Hydrocrackate | 160 ppm | 30 ppm |
| 2 fed to EKS with | Hydrocrackate | N/A | 32 ppm |
| no current | fed to EKS | | |
| 3 fed to EKS | Hydrocrackate | 65 ppm | 9 ppm |
| w/current applied | fed to EKS | | |

The data demonstrate that under the conditions used for the treatment, the hydrocrackate particulate level drops 60-70% using the charged EKS system. Subsequent analysis of the particulate revealed that the EKS treatment proportionally removes aluminum-based species.

### PCT and EP Clauses:

1. A process for reducing particulates in a hydrocarbon process stream, comprising either a hydrocracker feed stream or a hydrocrackate stream and particulates, the process comprising removing at least a portion of the particulates from the hydrocarbon process stream by passing the hydrocarbon process stream through at least one electrokinetic separator (EKS) to form a particulate-reduced hydrocarbon stream.

2. The process of paragraph 1, wherein the hydrocarbon process stream is a feed stream for a hydrocracker.

3. The process of paragraph 1, wherein the hydrocarbon process stream is hydrocrackate exiting a hydrocracker.

4. The process of any one of paragraphs 1 to 3, further comprising filtering the particulate-reduced hydrocarbon stream with sub-micron filters.

5. The process of paragraph 4, wherein the reduction in particulates off-loads the filters and reduces time for regenerating the filters.

6. The process of any one of paragraphs 1 to 5, further comprising processing the particulate-reduced hydrocarbon stream with a hydrocyclone system or a centrifuge system as a polishing step.

7. The process of any one of paragraphs 1 to 6, further comprising running the hydrocarbon stream through a hydrocyclone upstream of the EKS, or running the hydrocarbon stream through a filtration system upstream of the EKS, or even running the hydrocarbon stream through a centrifuge system upstream of the EKS.

8. The process of any one of paragraphs 1 to 7, wherein the particulates have an average particle size in the range from about 0.1 to about 1 micrometer.

9. The process of any one of paragraphs 1 to 8, wherein at least 50 wt % of the particulates are derived from a hydrocarbon processing catalyst, as measured by via a hot toluene filtration/wash protocol, ASTM method D4807-05.

10. The process of any one of paragraphs 1 to 9, wherein the particulates comprise particles derived from catalysts, clay, particles derived from reactor equipment, and particles derived from post-reaction treatment before the EKS.

11. The process of any one of paragraphs 1 to 10, wherein the EKS comprises at least two opposing electrodes with differing electrical potentials applying an electric field, and an EKS media disposed between the electrodes, wherein the EKS media comprises fibers, fabrics, flakes, foams, pellets, beads, wires, or combinations thereof.

12. The process of paragraph 11, wherein the EKS media comprises a fabric, and the process stream flows through a channel formed at least partially from the fabric.

13. The process of paragraph 11, wherein the EKS media comprises pellets made from materials selected from inorganic glasses, ceramics, glass-ceramics, inorganic oxides, and mixtures and combinations thereof.

14. The process of any one of paragraphs 11 to 13, further comprising a step of regenerating the EKS media, such as by washing the EKS media by recycling a portion of the particulate-reduced hydrocarbon stream to the EKS, thereby removing at least a portion of the particles collected in the EKS media, or by washing the EKS media by using a process-compatible washing fluid to remove at least a portion of the particles collected in the EKS media.

15. The process of paragraph 14, wherein the process-compatible washing fluid is selected from the group consisting of air, nitrogen, a hydrocarbon containing liquid and combinations thereof.

16. The process of any one of paragraphs 1 to 15, wherein the particulates are removed in a direction different from a flow direction of the hydrocarbon process stream.

### INDUSTRIAL APPLICABILITY

The systems and methods disclosed herein are applicable to the chemical industry.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A process for reducing particulates in a hydrocarbon process stream, comprising either a hydrocracker feed stream or a hydrocrackate stream and particulates, the process comprising removing at least a portion of the particulates from the hydrocarbon process stream by passing the hydrocarbon process stream through at least one electrokinetic separator (EKS) to form a particulate-reduced hydrocarbon stream.

2. The process of claim 1, wherein the hydrocarbon process stream is a feed stream for a hydrocracker.

3. The process of claim 1, wherein the hydrocarbon process stream is hydrocrackate exiting a hydrocracker.

4. The process of claim 1, further comprising filtering the particulate-reduced hydrocarbon stream with sub-micron filters.

5. The process of claim 4, wherein the reduction in particulates off-loads the filters and reduces time for regenerating the filters.

6. The process of claim 1, further comprising processing the particulate-reduced hydrocarbon stream with a hydrocyclone system or a centrifuge system as a polishing step.

7. The process of claim 1, further comprising running the hydrocarbon stream through a hydrocyclone upstream of the EKS.

8. The process of claim 1, further comprising running the hydrocarbon stream through a filtration system upstream of the EKS.

9. The process of claim 1, further comprising running the hydrocarbon stream through a centrifuge system upstream of the EKS.

10. The process of any of claim 1, wherein the particulates have an average particle size in the range from about 0.1 to about 1 micrometer.

11. The process of claim 1, wherein at least 50 wt % of the particulates are derived from a hydrocarbon processing catalyst.

12. The process of claim 1, wherein the particulates comprise particles derived from catalysts, clay, particles derived from reactor equipment, and particles derived from post-reaction treatment before the EKS.

13. The process of claim 1, wherein the EKS comprises:
at least two opposing electrodes with differing electrical potentials applying an electric field; and
an EKS media disposed between the electrodes,
wherein the EKS media comprises fibers, fabrics, flakes, foams, pellets, beads, wires, or combinations thereof.

14. The process of claim 13, wherein the EKS media comprises a fabric and the process stream flows through a channel formed at least partially from the fabric.

15. The process of claim 13, further comprising a step of regenerating the EKS media.

16. The process of claim 15, wherein the step of regenerating the EKS media comprises washing the EKS media by recycling a portion of the particulate-reduced hydrocarbon stream to the EKS, thereby removing at least a portion of the particles collected in the EKS media.

17. The process of claim 15, wherein the step of regenerating the EKS media comprises washing the EKS media by using a process-compatible washing fluid to remove at least a portion of the particles collected in the EKS media.

18. The process of claim 17, wherein the process-compatible washing fluid is selected from the group consisting of air, nitrogen, a hydrocarbon containing liquid and combinations thereof.

19. The process of claim 1, wherein the particulates are removed in a direction different from a flow direction of the hydrocarbon process stream.

20. A system, comprising:
a hydrocracker; and
an electrokinetic separator (EKS),
wherein the EKS is configured to remove at least a portion of particulates from a hydrocracker feed stream to form a particulate-reduced hydrocarbon stream, and the EKS is configured to feed the particulate-reduced hydrocarbon stream to the hydrocracker.
